(19) United States
(12) Patent Application Publication
(10) Pub. No.: US 2026/0093953 A1
(43) Pub. Date: Apr. 2, 2026

(54) CACHE-AWARE DYNAMIC MODULE SELECTION

(71) Applicant: QUALCOMM Incorporated, San Diego, CA (US)

(72) Inventors: Marinus Willem VAN BAALEN, Amsterdam (NL); Davide BELLI, Diemen (NL); Andrii SKLIAR, Diemen (NL); Bence MAJOR, Amsterdam (NL); Markus NAGEL, Amsterdam (NL); Babak EHTESHAMI BEJNORDI, Amsterdam (NL); Paul Nicholas WHATMOUGH, Cambridge, MA (US); Marco FEDERICI, Diemen (NL); Amir JALALIRAD, Amsterdam (NL)

(21) Appl. No.: 18/902,554

(22) Filed: Sep. 30, 2024

(51) Int. Cl. G06N 3/045; G06N 3/0475

(52) U.S. Cl. CPC G06N 3/045; G06N 3/0475

(57) ABSTRACT

Certain aspects of the present disclosure provide techniques and apparatus for cache aware dynamic module selection for a computation model. An example method generally includes generating at least one output, in a first inference round, using a first subset of modules of a computational model loaded in a cache memory from another memory, evaluating modules of the computational model to use for a second inference round, using a function that biases evaluation of the first subset of modules of the computational model already in the cache, and performing the second inference round with a second subset of modules of the computational module, based on the evaluation.

### INTRODUCTION

Aspects of the present disclosure relate to computational models, such as machine learning (ML) models.

A wide variety of machine learning model architectures have been trained to perform an assortment of diverse tasks, including computer vision tasks, language tasks, classification and regression tasks, and the like. Recently, research has yielded substantial success in using large models (e.g., deep neural networks, large language models (LLMs), large vison models (LVMs), large multimodal models (LMMs), and the like) to process and generate output data. Often, machine learning models induce substantial computational expense in inferencing (e.g., generating model output). This expense is particularly problematic on resource-constrained devices (e.g., smartphones).

Some attempts to mitigate the computational expense include caching portions of a model using various techniques to speed model execution. However, given the architectures of certain models, advantages in model execution speed may be offset by increased cache misses, resulting in latency if different portions of a model frequently need to be loaded from slower memory into cache.

### BRIEF SUMMARY

Certain aspects of the present disclosure provide a processor-implemented method, comprising: generating at least one output, in a first inference round, using a first subset of modules of a computational model loaded in a cache memory from another memory; evaluating modules of the computational model to use for a second inference round, using a function that biases evaluation of the first subset of modules of the computational model already in the cache; and performing the second inference round with a second subset of modules of the computational module, based on the evaluation.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 depicts an example workflow for cache management in machine learning models, according to some aspects of the present disclosure.

FIG. 2 depicts an example process for cache-aware computational model module selection, according to some aspects of the present disclosure.

FIG. 3 depicts an example of computational model module selection that is not cache-aware.

FIG. 4 depicts an example of cache-aware computational model module selection, according to some aspects of the present disclosure.

FIG. 5 depicts example performance results for cache-aware computational model module selection, according to some aspects of the present disclosure.

FIGS. 6A and 6B depict example performance results for cache-aware computational model module selection, according to some aspects of the present disclosure.

FIG. 7 is a flow diagram depicting an example method for cache-aware computational model module selection, according to some aspects of the present disclosure.

FIG. 8 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for improved computational model (e.g., ML model) performance. Specifically, in some aspects of the present disclosure, techniques for considering cache states when dynamically selecting model modules are provided.

Certain computation models (e.g., neural network models) that are too large to fit in high speed memory (e.g., dynamic random access memory-DRAM) may be run by streaming weights directly from other types of memory, such as flash memory. Since flash memory has much lower bandwidth than DRAM memory, streaming models from flash memory typically comes at a significant latency increase.

To mitigate the latency increase, certain applications may load only part of a model (e.g., using only part of a model's weights). For example, in mixture-of-expert (MoE) models, a subset of experts is used in each forward pass. With dynamic sparsity, a subset of neurons is activated in each forward pass. Using such approaches, data transferred from flash memory—and the corresponding latency increase—may be reduced.

For example, in applications such as LLM token generation, the same model is typically invoked for every token. When dynamic sparsity is applied to these models, or if these models are MoE models, a different subset of parameters (or ‘modules’) is used for each token.

As described above, when streaming models from flash memory, DRAM can be used as a cache. In such cases, modules that are in cache are loaded more quickly, reducing the latency increase. However, the effectiveness of a DRAM cache depends on the amount of overlap between modules used in consecutive tokens. If there is little overlap between the modules used in consecutive tokens a DRAM cache, cache misses will result, limiting the potential latency benefits.

Aspects of the present disclosure, however, provide techniques for considering cache states when dynamically selecting model modules are provided. As a result, cache missies may be reduced, increasing potential latency benefits, while maintaining good model accuracy. In this manner, the techniques proposed herein may represent a good trade-off between throughput and model accuracy.

### Example Workflow for Cache Management in Machine Learning Models

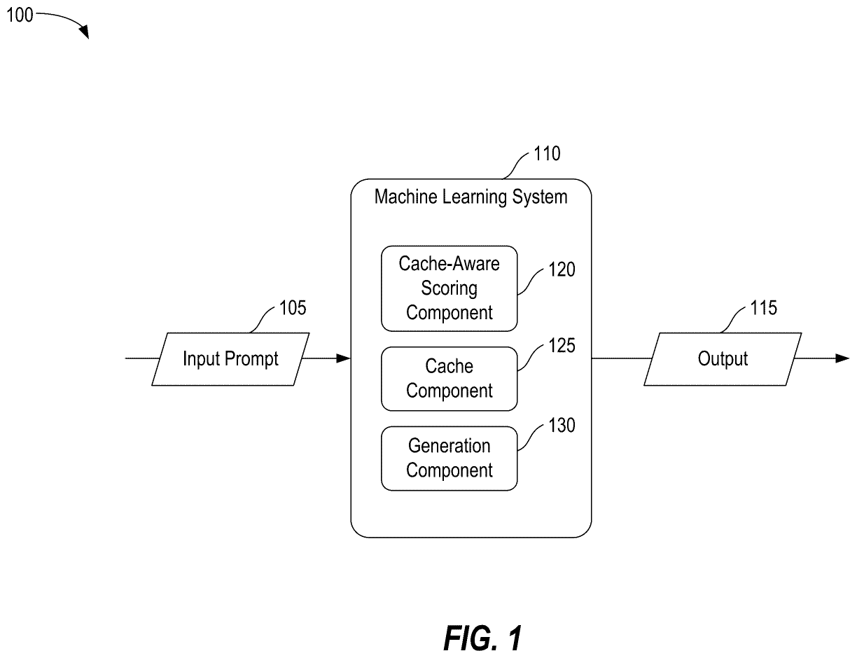

FIG. 1 depicts an example workflow 100 for utilizing cache in machine learning models, according to some aspects of the present disclosure.

In the depicted workflow 100, a machine learning system 110 accesses an input prompt 105 to generate an output 115. As used herein, “accessing” data may generally include receiving, requesting, retrieving, obtaining, generating, collecting, to otherwise gaining access to the data. Although depicted as a discrete computing system for conceptual clarity, in some aspects, the operations of the machine learning system 110 may be implemented using hardware, software, or a combination of hardware and software, and may be distributed across any number and variety of systems.

In some aspects, the input prompt 105 generally comprises an ordered sequence of elements (referred to as “tokens” in some aspects). The particular contents and format of the input prompt 105 may vary depending on the particular implementation. For example, if the machine learning system 110 comprises an LLM, the input prompt 105 may include natural language text (e.g., where each element or token corresponds to a character, word (or portion thereof), or phrase). Similarly, the particular content and format of the output 115 may vary depending on the particular implementation. For example, the output 115 may include a natural language textual string, an image, and the like.

In some aspects, the machine learning system 110 may comprise or implement one or more machine learning models (e.g., generative machine learning models such as diffusion models, LLMs, LVMs, LMMs, and the like). In some aspects, as part of the machine learning model operations, the machine learning system 110 may perform one or more attention operations (e.g., using transformers) to process the input data. As discussed above, attention operations (such as self-attention operations) generally use learned weight tensors to project input features (e.g., the elements of the input prompt 105 or features generated therefrom) to a set of intermediate data (e.g., query (Q), key (K), and value (V) matrices). These intermediate data tensors can then be combined or evaluated to generate an attention score for each respective token (e.g., for each element of the input prompt 105) based on the data contained in the respective token as well as the data contained in one or more other tokens in the input prompt 105.

In some aspects, each token in the input prompt 105 (or features generated therefrom) attends to each other token using the attention mechanism. However, as discussed above, performing this attention introduces substantial computational overhead (e.g., quadratic compute time and high memory usage). Further, as discussed above, some attempts have been made to mitigate or reduce the computational expense by introducing caching of some or all of the intermediate attention data. However, such caches can grow to unrealistic sizes quickly (especially in long-context generation). In the illustrated workflow 100, therefore, the machine learning system 110 can perform selective cache eviction by evicting data associated with token(s) having a low impact on the attention output (e.g., based on retention scores).

Specifically, in the illustrated example, the machine learning system 110 includes a cache-aware scoring component 120, a cache component 125, and a generation component 130. Although not included in the illustrated example, in some aspects, the machine learning system 110 may include other components, such as to train machine learning models (e.g., to learn the values for the matrices used to generate the queries, keys, and values, among other parameters). Although depicted as discrete components for conceptual clarity, in some aspects, the operations of the depicted components (and others not illustrated) may be combined or distributed across any number of components.

In the illustrated workflow 100, the scoring component 120 may be used to generate retention scores for tokens. As discussed above and in more detail below, the scoring component 120 may be configured to bias modules that are already in the cache, in order to reduce cache misses.

The cache component 125 may generally be used to maintain the cache while processing data using the machine learning model. For example, in some aspects, the cache component 125 may store intermediate data (e.g., key tensors and value tensors) for tokens as the keys and values are generated (e.g., as new tokens are processed). In some aspects, for each new token, the cache component 125 may evaluate the retention scores of each token remaining in the cache (generated by the scoring component 120), and may evict one or more tokens to maintain the size of the cache. For example, for each new token, the cache component 125 may evict the token having the lowest retention score (to make room to store the keys and values of the new token).

The generation component 130 may generally be used to generate new tokens for the output 115 of the machine learning system 110. For example, if the machine learning system 110 corresponds to or uses an LLM, the generation component 130 may generate the output tokens (e.g., words, phrases, characters, and the like) conditioned on the input prompt 105. In some aspects, each time a new token in the output 115 is generated, the scoring component 120 may similarly generate new retention scores and the cache component 125 may update the cache accordingly.

Specifically, in some aspects, the workflow 100 may begin with consumption or ingestion of the input prompt 105. In some aspects, the machine learning system 110 may ingest the input prompt 105 sequentially (e.g., one token at a time, in the order given in the input prompt 105). For example, suppose the prompt is N tokens long, the memory budget (e.g., the maximum size of the cache) is W tokens, and the maximum size of the output 115 is M tokens. In some aspects, the machine learning system 110 may first iterate over the first W tokens of the input prompt 105, caching the intermediate data (e.g., keys and values) for each token.

### Example Cache-Aware Dynamic Module Selection

As noted above, some attempts to mitigate the computational expense include caching portions of a model using various techniques to speed model execution. However, given the architectures of certain models, advantages in model execution speed may be offset by increased cache misses, resulting in reduced to no effect on latency if different portions of a model frequently need to be loaded from slower memory into cache.

Aspects of the present disclosure, however, provide techniques for considering cache states when dynamically selecting model modules are provided. As a result, cache misses may be reduced, increasing potential latency benefits.

The techniques may be used in machine learning (ML) model approaches that load only part of a model at a time, such as Mixture of experts (MoE) and dynamic sparsity. MoE generally refers to an ML technique where multiple expert networks (learners) are used to divide a problem space into homogeneous regions. With dynamic sparsity, a subset of neurons may be activated in each forward pass, effectively resulting in sparse networks that can be efficiently run on limited hardware.

While examples are provided herein for applying the techniques to these types of machine learning models, the techniques proposed herein may be more generally applied to any type of computational model where portions of the model are loaded and cached based on scoring.

Generally, using the scores discussed above, tokens having smaller scores may be less likely to be loaded and/or more likely to be evicted from the cache. As described in greater detail below, aspects of the present disclosure consider the cache state of modules when generating scores, such that modules already in the cache may be biased to achieve higher scores.

Notation for score based parameter loading may be described as follows. A value K may represent a number of modules to keep for each token and there may be a set of N modules mₙ. Cache states c_{t,n}, t=0 . . . T−1, n=0 . . . N−1, may indicate whether module mₙ is present in the DRAM cache for token t.

A score s_{t,n}, t=0 . . . T−1, n=0 . . . N−1; s_{t,n}≥0 may indicate the importance of module mₙ for token t. For each token t, the modules with the top-K (highest) scores may be used. In other words, if score s_{t,n} is in the top-K scores for token t, then module mₙ is active and loaded. Thus, if a module mₙ is selected, but not present in DRAM cache, mₙ must be loaded (e.g., from flash memory).

When a new module mₙ is loaded but the cache is full, the system needs to evict modules from cache. A cache eviction policy decides on which modules can be removed when the cache is full.

One example of a commonly used cache eviction policy is the least-recently-used cache policy (LRU). Under the LRU cache eviction policy, mₙ may be stored in the cache after loading. If the cache is full, modules that were LRU are evicted, until the maximum cache size is reached. After this step, for all n, ∀ₙ: c_{t,n} is updated to reflect the state of the DRAM cache at token t.

By biasing scores s_{t,n} to favor modules that are (already) in cache at token t−1, the cache-aware scoring proposed herein may help reduce cache misses and, as a result, reduce latency.

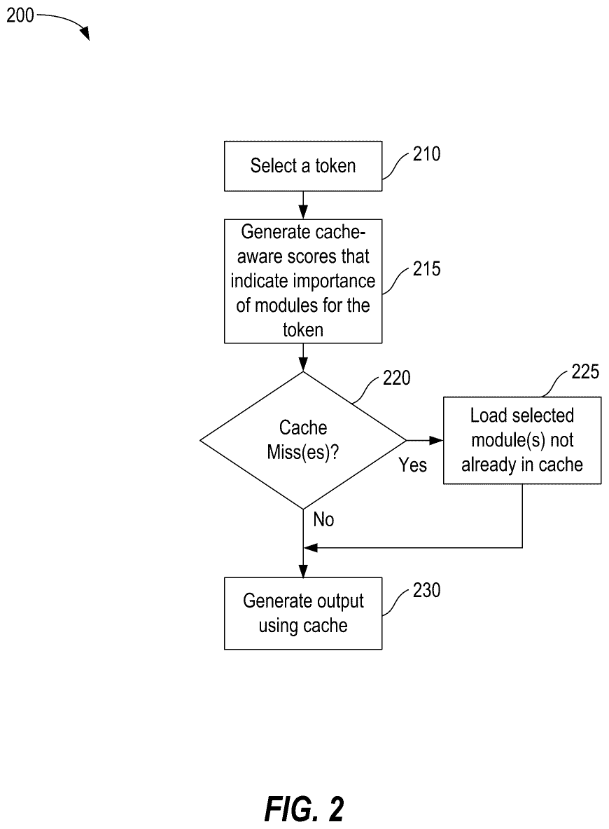

FIG. 2 is a flow diagram depicting an example method 200 for cache-aware dynamic module selection in machine learning models, according to some aspects of the present disclosure. In some aspects, the method 200 is performed by a machine learning system, such as the machine learning system 110 of FIG. 1.

At block 210, a token is selected (e.g., from an input prompt). Generally, the machine learning system may select the token using a variety of techniques. In some aspects, the machine learning system selects the tokens, from an input prompt, sequentially. That is, the machine learning system may ingest the prompt sequentially (e.g., such that each token is processed or evaluated based on the prior token(s) in the prompt).

At block 215, cache-aware scores are generated that indicate importance of modules for the token. As noted above, a typical scoring algorithm may be modified to bias modules already in the cache. The top K modules may be selected, based on the cache-aware scores. If one or more modules are not already in the cache, resulting in a cache miss as indicated at block 220, those modules may be loaded at block 225. At 230, output is generated, using the cached modules.

While modifying the scores may lead to suboptimal module choices (e.g., in terms of model accuracy), the cache-aware based choices may result in a better trade-off between latency and accuracy by taking into account both the score s_{t,n} and the cache state c_{t-1,n}.

In some cases, cache-aware biasing may be achieved by effectively reweighting the scores s_{t,n} to include the cache state at token t−1:

$${\hat{s}}_{t , n} = ( 1 - γ ) \frac{{s}_{t , n}}{{\vert {s}_{t , :} \vert}_{∞}} + γ \cdot {c}_{t - 1 , n} . \qquad Eq . 1$$

In Equation 1, γ is a tunable parameter, for example, between 0 and 1 (∈[0,1]), allowing different trade-offs between latency and accuracy. In other words, setting this parameter to zero effectively zeros out the biasing. Setting this parameter to a non-zero value effectively gives each score gets a bonus (via the γ·c_{t-1,n} term) if the corresponding module was already in DRAM cache for the previous token t−1.

As shown above, Equation 1 includes a normalization term |s_{t,:}|_{∞}. The normalization term |s_{t,:}|_{∞} may help to ensure the γ parameter is consistent across tokens.

In some cases, a de-biasing may be performed because otherwise, for large values of γ, the method may overly bias modules with high scores for the first token. This can be compensated for by using:

$${\hat{γ}}_{t} = ( 1 - {γ}^{t} ) γ , \qquad Eq . 2 ,$$

and replacing γ in Equation 1 with \hat{γ} from Equation 2.

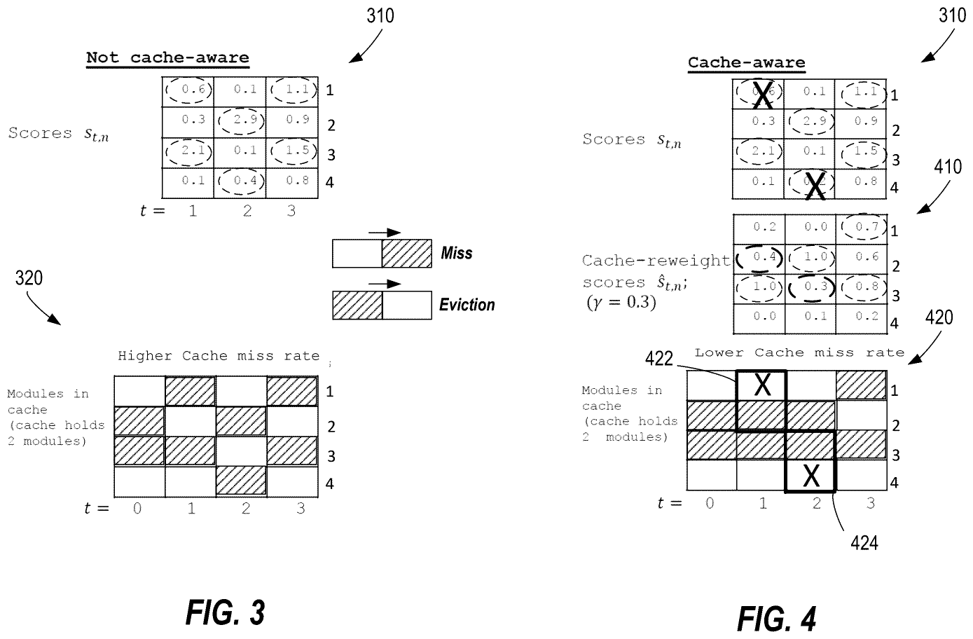

The impact of cache-aware reweighting on module selection and cache hit rate may be understood with reference to FIGS. 3 and 4.

In FIG. 3, table 310 shows an example of (non cache-aware) scoring that does not consider cache state of modules. The example assumes the top-2 modules are selected. Table 310 shows example scores for 4 modules at different times (tokens) 1, 2, and 3.

As illustrated, for t=1, modules 1 and 3 have the highest scores (0.6 and 2.1, respectively). As indicated in table 320, modules 2 and 3 are cached at t=0. Thus, selection of module 1 for t=1 results in a cache miss (and eviction of module 2) as module 1 is loaded from flash.

For t=2, modules 2 and 4 have the highest scores (2.9 and 0.4, respectively). As indicated in table 320, modules 1 and 3 are cached at t=1. Thus, selection of modules 2 and 4 for t=2 results in two cache misses (and eviction of modules 1 and 3) as modules 2 and 4 are loaded from flash.

For t=3, modules 1 and 3 again have the highest scores (1.1 and 1.5, respectively). As indicated in table 320, modules 2 and 4 are cached at t=2. Thus, selection of modules 1 and 3 for t=3 results in two more cache misses (and evictions of modules 2 and 4) as modules 1 and 3 are again loaded from flash.

In FIG. 4, table 410 shows an example of (cache-aware) scoring that does consider cache state of modules.

As illustrated in table 410, for t=1, because module 2 is already cached, it is given a higher score (0.4) than with non cache aware scoring (which gave it 0.3). Further, the cache-aware scoring resulted in module 1, which is not in the cache at t=0, having a reduced score (of 0.2). As a result, with the cache re-weighted scores, modules 2 and 3 are selected. Thus, as indicated at block 422, selecting module 2 rather than module 1 avoids a cache miss.

For t=2, because module 3 is already cached, it is given a higher score (0.3 in table 410) than with non cache aware scoring (which gave it 0.1). Further, the cache-aware scoring resulted in module 4, which is not in the cache at t=0, having a reduced score (of 0.1). As a result, with the cache re-weighted scores, modules 2 and 3 are again selected. Thus, as indicated at block 424, selecting module 3 rather than module 4 avoids another cache miss.

For t=3, modules 1 and 3 have the highest scores (0.7 and 0.8, respectively). Since module 1 is not already in cache, its selection results in a cache miss. However, since module 3 is already in cache an additional cache miss is avoided.

As noted above, the techniques proposed herein may be used for a variety of ML model approaches, such as MoE and dynamic sparsity.

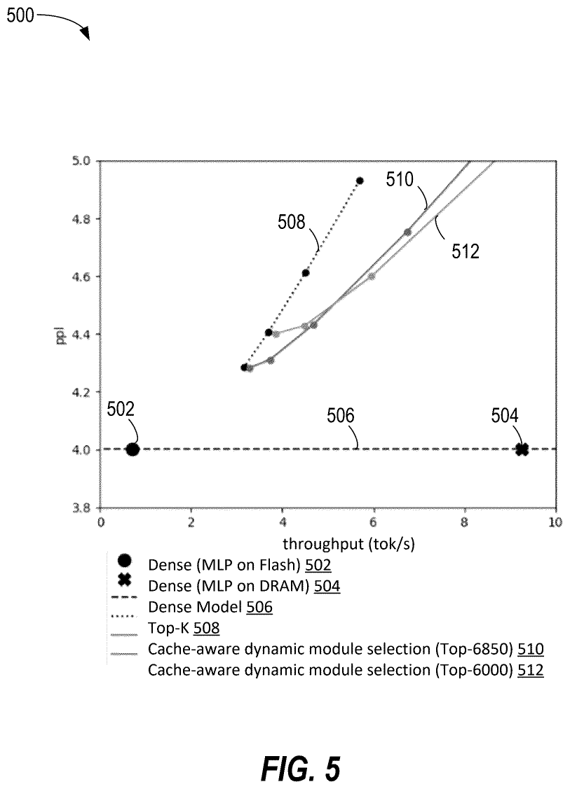

FIG. 5 depicts example performance results for cache-aware computational model module selection for dynamically sparse LLMs, according to some aspects of the present disclosure. FIG. 5 compares the cache-aware module selection proposed herein to a non cache-aware approach, for example, where least frequently used (LFU) modules are evicted. The plot for the LFU approach is labeled 508.

In the example scenario, each module corresponds to all model weights connected to a neuron (input and output). Out of an example total of 13,700 modules, plot 512 shows achievable throughput when picking the top-6,000 (K=6000), while plot 510 shows achievable throughput when picking the top-6,850 (K=6850).

As illustrated, Lower K in the top-K selection yields higher throughput but also higher accuracy. As illustrated, the cache-aware module selection results in throughput significantly better than running the entire (dense) model out of flash (as indicated at 502) and approaching the throughput if the entire (dense) model were cached (as indicated at 504).

These plots show the achievable trade-offs between throughput in tokens/second (the x-axis where higher is better) and perplexity (ppl-the y-axis, where lower is better). In other words, better performing methods tend towards the bottom right corner of the plot. The results in the illustrated examples demonstrate how the cache-aware module selection generally outperforms the LFU approach, in terms of throughput vs accuracy trade-offs.

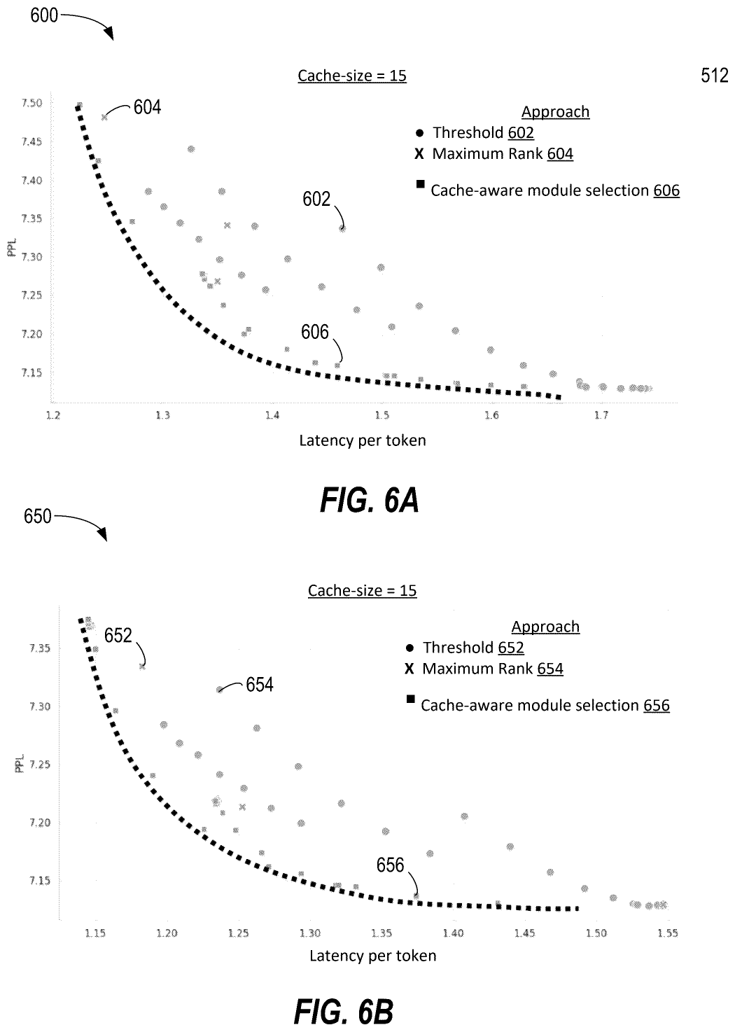

FIGS. 6A and 6B depict example performance results for cache-aware module selection for MoE models, according to some aspects of the present disclosure. In these scenarios, each module corresponds to an ‘expert.’ The examples assume that, for each token, 6 experts are chosen out of 64 total experts.

Graph 600 of FIG. 6A assumes a cache that fits 15 experts, while FIG. 6B Graph 650 of FIG. 6B assumes a cache that fits 24 experts.

These graphs compare the techniques proposed herein to other techniques for enforcing cache-consistency (e.g., a threshold approach plotted with points 602 and a maximum rank approach plotted with points 604 in FIG. 6A and 654 in FIG. 6B).

The graphs help evaluate these various methods on achievable trade-offs between relative latency per token (where lower, left on the graphs is better) and perplexity (where lower. bottom on the graphs is better). In other words, the better performing methods tend towards the bottom left corner of the plot. As indicated by points 606 in FIG. 6A and 656 in FIG. 6B, the cache-aware module selection proposed herein generally outperforms the other cache-consistency methods, in terms of latency vs accuracy trade-offs.

### Example Method for Cache-Aware Dynamic Module Selection

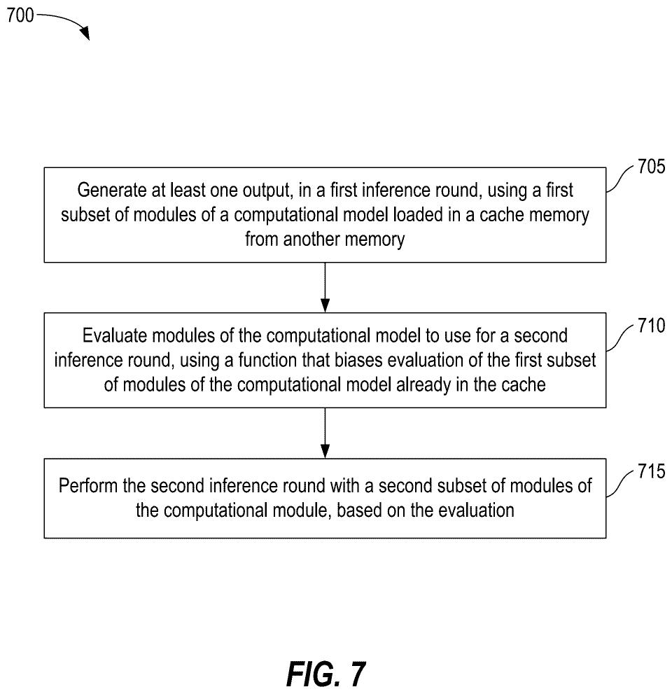

FIG. 7 is a flow diagram depicting an example method 700 for data eviction in machine learning models, according to some aspects of the present disclosure. In some aspects, the method 700 is performed by a machine learning system, such as the machine learning system 110 of FIG. 1 and/or the machine learning system discussed above with reference to FIGS. 2-6.

At block 705, at least one output is generated, in a first inference round, using a first subset of modules of a computational model loaded in a cache memory from another memory.

At block 710, modules of the computational model are evaluated for use for a second inference round, using a function that biases evaluation of the first subset of modules of the computational model already in the cache.

At block 715, the second inference round is performed with a second subset of modules of the computational module, based on the evaluation.

### Example Processing System for Cache-Aware Dynamic Module Selection

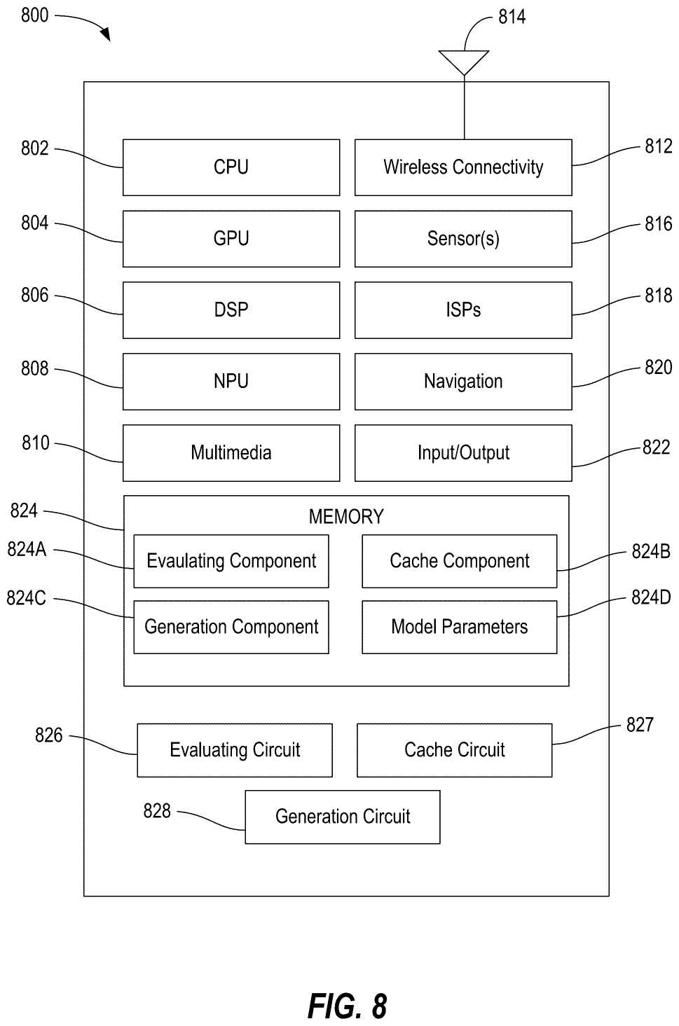

FIG. 8 depicts an example processing system 800 configured to perform various aspects of the present disclosure, including, for example, the techniques and methods described with respect to FIGS. 1-7. In some aspects, the processing system 800 may correspond to a machine learning system. For example, the processing system 800 may correspond to the machine learning system 110 of FIG. 1 and/or the machine learning system discussed above with reference to FIGS. 2-7. Although depicted as a single system for conceptual clarity, in some aspects, as discussed above, the components described below with respect to the processing system 800 may be distributed across any number of devices or systems.

The processing system 800 includes a central processing unit (CPU) 802, which in some examples may be a multi-core CPU. Instructions executed at the CPU 802 may be loaded, for example, from a program memory associated with the CPU 802 or may be loaded from a memory partition (e.g., a partition of a memory 824).

The processing system 800 also includes additional processing components tailored to specific functions, such as a graphics processing unit (GPU) 804, a digital signal processor (DSP) 806, a neural processing unit (NPU) 808, a multimedia component 810 (e.g., a multimedia processing unit), and a wireless connectivity component 812.

An NPU, such as the NPU 808, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 808, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference). In some implementations, the NPU 808 is a part of one or more of the CPU 802, the GPU 804, and/or the DSP 806.

In some examples, the wireless connectivity component 812 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 812 is further coupled to one or more antennas 814.

The processing system 800 may also include one or more sensor processing units 816 associated with any manner of sensor, one or more image signal processors (ISPs) 818 associated with any manner of image sensor, and/or a navigation processor 820, which may include satellite-based positioning system components (e.g., GPS or GLONASS) as well as inertial positioning system components.

The processing system 800 may also include one or more input and/or output devices 822, such as screens, touch-sensitive surfaces (including touch-sensitive displays), physical buttons, speakers, microphones, and the like.

In some examples, one or more of the processors of the processing system 800 may be based on an ARM or RISC-V instruction set.

The processing system 800 also includes a memory 824, which is representative of one or more static and/or dynamic memories, such as a dynamic random access memory, a flash-based static memory, and the like. In this example, the memory 824 includes computer-executable components, which may be executed by one or more of the aforementioned processors of the processing system 800.

In particular, in this example, the memory 824 includes an evaluating component 824A, a cache component 824B, and a generation component 824C. Although not depicted in the illustrated example, the memory 824 may also include other components, such as a training component used to train or update machine learning model(s). Though depicted as discrete components for conceptual clarity in FIG. 8, the illustrated components (and others not depicted) may be collectively or individually implemented in various aspects.

Further, in the illustrated example, the memory 824 also includes model parameters 824D (e.g., parameters of one or more machine learning models, such as an LLM). Although not depicted in the illustrated example, in some aspects, the memory 824 may include other data such as a training data for the machine learning model(s), prior prompt(s) processed by the machine learning model(s), prior outputs generated by the machine learning model(s), and the like.

The processing system 800 further comprises an evaluating circuit 826, a cache circuit 827, and a generation circuit 828. The depicted circuits, and others not depicted (such as an inferencing circuit), may be configured to perform various aspects of the techniques described herein.

Though depicted as separate components and circuits for clarity in FIG. 8, the evaluating circuit 826, the cache circuit 827, and the generation circuit 828 may collectively or individually be implemented in other processing devices of the processing system 800, such as within the CPU 802, the GPU 804, the DSP 806, the NPU 808, and the like.

Generally, the processing system 800 and/or components thereof may be configured to perform the methods described herein.

Notably, in other aspects, aspects of the processing system 800 may be omitted, such as where the processing system 800 is a server computer or the like. For example, the multimedia component 810, the wireless connectivity component 812, the sensor processing units 816, the ISPs 818, and/or the navigation processor 820 may be omitted in other aspects. Further, aspects of the processing system 800 may be distributed between multiple devices.

### EXAMPLE CLAUSES

Implementation examples are described in the following numbered clauses:

Clause 1: A processor-implemented method, comprising: generating at least one output, in a first inference round, using a first subset of modules of a computational model loaded in a cache memory from another memory; evaluating modules of the computational model to use for a second inference round, using a function that biases evaluation of the first subset of modules of the computational model already in the cache; and performing the second inference round with a second subset of modules of the computational module, based on the evaluation.

Clause 2: The method of Clause 1, wherein the computational model comprises a machine learning (ML) model.

Clause 3: The method of Clause 2, wherein: the ML model comprises a generative artificial intelligence model; and the plurality of modules correspond to Mixture of Expert (MoE) sub-models for the generative artificial intelligence model.

Clause 4: The method of Clause 2, wherein the plurality of modules correspond to unique sets of neurons in a neural network-based machine learning model.

Clause 5: The method of Clause 2, wherein the function generates a score that indicates an importance of each module for an output.

Clause 6: The method of Clause 5, wherein: at least one output comprises a token generated as a response or part of a response to an input query; and the function generates a score that indicates an importance of each module for the token.

Clause 7: The method of any one of Clause 5, wherein a quantity of modules of the ML model are loaded from the other memory into the cache memory, based on the scores generated by the function.

Clause 8: The method of Clause 5, wherein the function has a component that increases the score for a module already in the cache.

Clause 9: The method of Clause 8, wherein the function also involves a parameter that be adjusted to tune the amount the score is increased for a module already in the cache.

Clause 10: The method of Clause 9, wherein the function also includes a normalization component designed to ensure the parameter is applied consistently across outputs.

Clause 11: The method of Clause 9, wherein the function also includes a debiasing component designed to reduce bias to modules with high scores for tokens in earlier inference rounds.

Clause 12: An apparatus, comprising: at least one memory comprising executable instructions; and at least one processor configured to execute the executable instructions and cause the apparatus to perform a method in accordance with any combination of Clauses 1-11.

Clause 13: An apparatus, comprising means for performing a method in accordance with any combination of Clauses 1-11.

Clause 14: A non-transitory computer-readable medium comprising executable instructions that, when executed by at least one processor of an apparatus, cause the apparatus to perform a method in accordance with any combination of Clauses 1-11.

Clause 15: A computer program product embodied on a computer-readable storage medium comprising code for performing a method in accordance with any combination of Clauses 1-11.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system comprising:
one or more memories comprising processor-executable instructions; and
one or more processors coupled to the one or more memories and configured to execute the processor-executable instructions and cause the processing system to:
generate at least one output, in a first inference round, using a first subset of modules of a computational model loaded in a cache memory from another memory;
evaluate modules of the computational model to use for a second inference round, using a function that biases evaluation of the first subset of modules of the computational model already in the cache; and
perform the second inference round with a second subset of modules of the computational module, based on the evaluation.

2. The processing system of claim 1, wherein the computational model comprises a machine learning (ML) model.

3. The processing system of claim 2, wherein:
the ML model comprises a generative artificial intelligence model; and
the plurality of modules correspond to Mixture of Expert (MoE) sub-models for the generative artificial intelligence model.

4. The processing system of claim 2, wherein the plurality of modules correspond to unique sets of neurons in a neural network-based machine learning model.

5. The processing system of claim 2, wherein the function generates a score that indicates an importance of each module for an output.

6. The processing system of claim 5, wherein:
at least one output comprises a token generated as a response or part of a response to an input query; and
the function generates a score that indicates an importance of each module for the token.

7. The processing system of claim 5, wherein a quantity of modules of the ML model are loaded from the other memory into the cache memory, based on the scores generated by the function.

8. The processing system of claim 5, wherein the function has a component that increases the score for a module already in the cache.

9. The processing system of claim 8, wherein the function also involves a parameter that be adjusted to tune the amount the score is increased for a module already in the cache.

10. The processing system of claim 9, wherein the function also includes a normalization component designed to ensure the parameter is applied consistently across outputs.

11. The processing system of claim 9, wherein the function also includes a debiasing component designed to reduce bias to modules with high scores for tokens in earlier inference rounds.

12. A processor-implemented method, comprising:
generating at least one output, in a first inference round, using a first subset of modules of a computational model loaded in a cache memory from another memory;
evaluating modules of the computational model to use for a second inference round, using a function that biases evaluation of the first subset of modules of the computational model already in the cache; and
performing the second inference round with a second subset of modules of the computational module, based on the evaluation.

13. The method of claim 12, wherein the computational model comprises a machine learning (ML) model.

14. The method of claim 13, wherein:
the ML model comprises a generative artificial intelligence model; and
the plurality of modules correspond to Mixture of Expert (MoE) sub-models for the generative artificial intelligence model.

15. The method of claim 13, wherein the plurality of modules correspond to unique sets of neurons in a neural network-based machine learning model.

16. The method of claim 13, wherein the function generates a score that indicates an importance of each module for an output.

17. The method of claim 16, wherein:
at least one output comprises a token generated as a response or part of a response to an input query; and
the function generates a score that indicates an importance of each module for the token.

18. The method of claim 16, wherein a quantity of modules of the ML model are loaded from the other memory into the cache memory, based on the scores generated by the function.

19. The method of claim 16, wherein the function has a component that increases the score for a module already in the cache.

20. A processing system, comprising:
means for generating at least one output, in a first inference round, using a first subset of modules of a computational model loaded in a cache memory from another memory;
means for evaluating modules of the computational model to use for a second inference round, using a function that biases evaluation of the first subset of modules of the computational model already in the cache; and
means for performing the second inference round with a second subset of modules of the computational module, based on the evaluation.
